(19) United States
(12) Patent Application Publication
(10) Pub. No.: US 2008/0262399 A1
(43) Pub. Date: Oct. 23, 2008

(54) Medical device

(75) Inventors: Harry Kovelman, Pikesville, MD (US); William J. Donohue, Cockeysville, MD (US); Scott Tarantino, Cockeysville, MD (US)

Correspondence Address: CROWELL & MORING LLP;INTELLECTUAL PROPERTY GROUP, P.O. BOX 14300, WASHINGTON, DC, 20044-4300, US

(73) Assignee: Clotbuster LLC, Cockeysville, MD (US)

(21) Appl. No.: 11/785,900

(22) Filed: Apr. 20, 2007

(51) Int. Cl. A61H 23/04

(52) U.S. Cl. 601/152

(57) ABSTRACT

A self-contained mechanical prophylaxis device and method is provided in which a non-rigid extremity compression sleeve, such as an elastic stocking is provided with an inflatable bladder system to apply pressure to the extremity, and inflation and control components are provided on or in stocking itself. The inflation and control components are preferably located within a common housing and held within a pouch or pocket on or near the compression sleeve. One or more bladders may be pneumatically inflated by the inflation components, which respond to inflation and/or venting commands issued by the control component. Preferably, the bladders are inflated in a sequential pattern to enhance the effectiveness of the VTED protection. The control program may include a single inflation control program, or may be one of several selectable control programs provided to the control component.

### BACKGROUND AND SUMMARY OF THE INVENTION

The present invention is directed to a device for prevention of deep vein thrombosis, and a method of using the device.

Venous thromboembolic disease (VTED) is considered to be one of the most common causes of preventable morbidity and mortality in the United States, especially in the hospitalized patient population. Mechanical prophylaxis, mostly consisting of compression sleeves (for example, in lower extremities, boots for the thigh, calf, foot, or some combination thereof, has been shown to effectively lower the incidence of deep venous thrombosis (DVT), and perhaps pulmonary embolism (PE), in the inpatient medical and surgical population. Such prophylaxis is applicable to essentially any inpatient, regardless of his or her subspecialty needs. In other settings, the devices may be used to increase circulation or for general massage.

The mechanical prophylaxis devices currently available in the marketplace require an outside source of air compression and power, mandating that the patient be always “attached” to an external compressor as well as a separate power source. This leads to at least the following problems with these devices:

Patient compliance is an issue because patients need to be detached from, and subsequently reattached to, the devices when they are transported for testing, x-rays, physical therapy, etc., or even when being moved from the bed to a chair. This makes nursing care more difficult and cuts down on the use of the device, rendering them ineffective.

The mechanical prophylaxis devices' external air compressor attachments are expensive. Thus, patients are not provided with compressors or compression sleeves upon discharge from the hospital, leaving them vulnerable to VTED at a time when they remain at risk.

Use of the currently available mechanical prophylaxis devices is difficult, and often impractical, in a surgical context where it is undesirable to have components and/or connections to external sources (for example, pneumatic conduits) which cross the “sterile boundary” of the surgical theater.

The present invention addresses these and other problems with the previous mechanical prophylaxis devices by providing a self-contained mechanical prophylaxis device in which a non-rigid extremity compression sleeve, such as a stocking (for example, in the case of lower extremities, a calf or thigh-high stocking), is provided with an inflatable bladder system in or on the sleeve to apply pressure to the extremity. Inflation and control components are provided on or in sleeve itself.

The inflation and control components are preferably located within a common housing, but may also be located in separate housings, as long as both components are located on or in the compression sleeve, or in close proximity to the compression sleeve so that there are no encumbering hoses or other elements which restrict patient use of the device or their mobility. The inflation and control components are preferably held within a pouch or pocket on the compression sleeve, but may also be held on the sleeve by other attachment features, such as a Velcro strap.

The inflatable bladder system contains one or more bladders (referred to herein as “inflation bladders,” “compression bladders” or “bladders”) which may be pneumatically inflated by the inflation components, which respond to inflation and/or venting commands issued by the control component. In the case where more than one inflation bladder is present, the control component may command simultaneous or separate inflation and/or venting of the individual bladders. Preferably, the bladders are inflated in a sequential pattern to enhance the effectiveness of the VTED protection, in response to a control program executed by the control component. The control component may be one of a variety of control devices, such as a microprocessor which executes one of several selectable control programs provided to the control component. Alternatively, the control component may include a Complex Programmable Logic Device (“CPLD”), a circuit type well known in the medical device art and therefore not discussed further herein, which is designed to permit the control component to control device inflation and deflation in accordance with pre-determined operating routines. Hereinafter, the terms “program,” “programmable” and “programmed” will be used to refer generally to any form of operating sequence, including programs associated with a microprocessor and routines followed by a CPLD.

Preferably, when the control component includes multiple, selectable programs, there is provided a control program selection mechanism such as one or more switches, as well as indication lights (for example, low-power light-emitting diodes (“LEDs”)), which permit an operator, preferably a physician or an appropriately-trained technician, to select an appropriate bladder inflation sequence program.

Alternatively, the control component may be designed to sense the number of compression bladders present when the inflation and control components are connected to the compression sleeve, for example by applying pressure to the line or lines leading to the inflation bladders, and determining by the response of pressure sensors whether a bladder is present at the end of each line. This approach would permit the use of standardized multi-port connectors between the inflation lines and the inflation component, with the control component determining whether any of the ports of the connector are blocked, for example where a compression sleeve is provided with only one inflation bladder. The control component could then automatically actuate a control program which is tailored to the appropriate number of bladders, in this example a program which inflates only the single bladder.

The inflation and control components may be powered by a portable energy source, preferably a rechargeable battery pack. Alternatively, the inflation and control components may be powered by a power supply which may be plugged into a wall outlet-type electric circuit, either to recharge a rechargeable battery and/or to power the inflation and control components when battery power is not available.

The inflation component may include at least one air compressor, although other pneumatic pressure supply devices may be used in lieu of a compressor, such as compressed gas storage containers. The inflation component may also include at least one solenoid-operated valve which, in response to commands from the control component, selectively controls inflation and venting of the compression bladder(s) by sealing and/or unsealing a vent path to the atmosphere and/or a conduit through which the compressed inflation gas is provided. Preferably, where more than one inflation bladder is present, more than one solenoid valve is provided, so that the inflation and/or venting of the bladders may be individually controlled, for example, in a sequential gradient compression pattern.

The compression sleeve may be a tubular, preferably elastic, non-rigid sleeve which surrounds the extremity, or may be arranged to partially surround the extremity, with, for example, straps joining the sides of the partial sleeve to on another to secure the sleeve to the extremity and to prevent undue expansion of the sleeve radially away from the extremity. Each compression bladder is preferably provided on an inside surface of the non-rigid compression sleeve in order to maximize the pressure applied by the bladder to the extremity. Alternatively, the bladder(s) may be provided within layers of the compression sleeve.

The inventive mechanical prophylaxis device may have its pneumatic conduits from the inflation component to the one or more bladders integrated either on or, preferably, within the non-rigid compression sleeve. A particularly preferred embodiment will have the pneumatic lines pass through the compression sleeve, with a selectively-connectable pneumatic connection component provided at the pouch holding the inflation and control components, such that the entire operating system of the mechanical prophylaxis device is part of, or nearby, the compression sleeve (preferably, concealed and protected within the compression sleeve). Such an arrangement also provides an operationally convenient approach to providing a way to separate and remove the “hard good” (i.e., the inflation and/or control components) from the pneumatic conduits to permit easy removal of the hard good.

The present invention provides a number of advantages over the prior art. Among these is the fact that with no need for an external attachment, patients may be transported or moved with the device in place. This will allow for increased compliance, and in turn, a more effective mechanical prophylaxis device. Ideally, the patient will be able to walk with the device in place. Nursing care will improve as time will no longer be used for frequent detaching and reattaching the cumbersome prior art inflation systems, for example, when a patient moves between hospital facilities and/or to/from sanitary facilities.

The lack of dependence on cumbersome external equipment, and consequent need for the patient to be “tethered” by connections to external equipment, allows patients to leave a hospital environment while still being served by a device which may help prevent the incidence of deep venous thrombosis. This will allow increased protection for the patients against VTED at a time when they remain at risk in an ambulatory setting. It is expected that the convenience of this self-contained, portable device will increase patient compliance. Further, with appropriately configured devices, there will be provided simple and convenient alteration of inflation patterns on an as needed basis by the patient's care-giver. The self-contained nature of the inventive mechanical prophylaxis device also eliminates any concern with violation of the “sterile boundary” in surgical settings, as it eliminates the need for cross-boundary connections to external inflation and control equipment.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an embodiment of a mechanical prophylaxis device in accordance with the present invention for use on a lower extremity.

FIG. 2 shows an embodiment of a compressor and controller unit for use with the mechanical prophylaxis device of FIG. 1.

FIGS. 3a-c shows various views of the upper section of the compressor and controller unit of FIG. 2.

FIGS. 4a-c shows various views of a lower section of the compressor and controller unit of FIG. 2.

FIGS. 5a-c shows various views of the compressor and controller elements housed within the lower section of the compressor and controller unit of FIGS. 4a-c.

### DETAILED DESCRIPTION

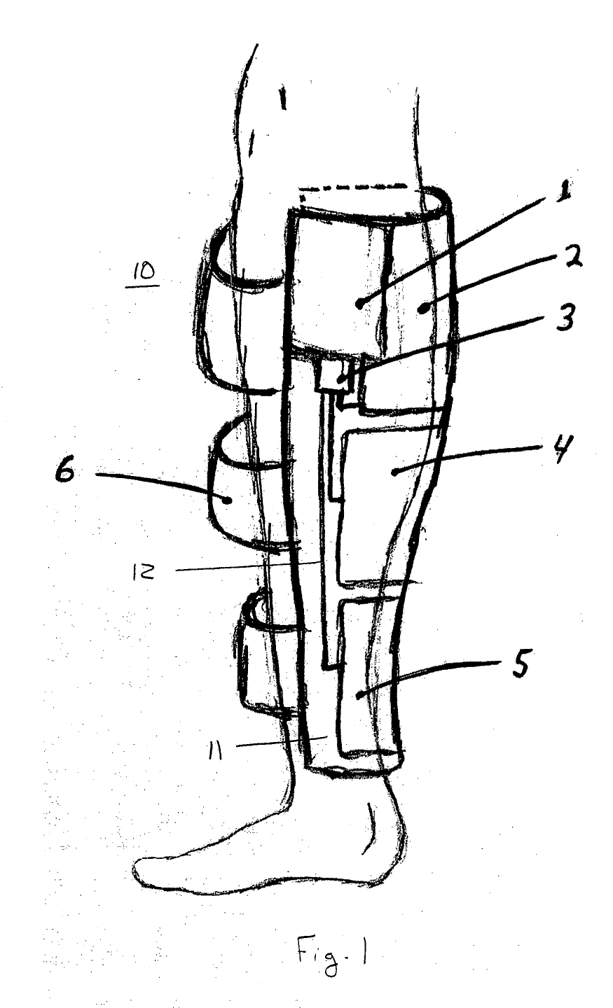

FIG. 1 shows an embodiment of the present invention for use on the calf of a patient. The mechanical prophylaxis device 10 includes a non-rigid compression sleeve with a bladder-bearing section 11 and securing straps 6. The securing straps preferably use Velcro® attachment strips or other suitable attachment device (not illustrated) to secure compression sleeve to the patient's leg, and to increase the effectiveness of the pressure application by the bladders by resisting radial expansion of the compression sleeve during bladder inflation.

The bladder-bearing section 11 of the compression sleeve includes, in this embodiment, three inflatable compression bladders 2, 4, 5. The bladders in this embodiment are located on an inside surface of the section 11, between section 11 and the patient's leg. The bladders may be positioned elsewhere, such as between layers of the non-rigid compression sleeve or even outside the sleeve, as long as adequate therapeutic pressure can be applied to the patient's appendage. The number and arrangement of bladders is not limited to the three shown bladders, but may be a single bladder, two or more bladders, or a plurality of bladders which includes at least one bladder “chain” in which multiple bladders are supplied inflating air by the same pneumatic source, in series or in parallel. The bladders may also be inflated by a pressure medium other than air, such as by a warm or cold liquid.

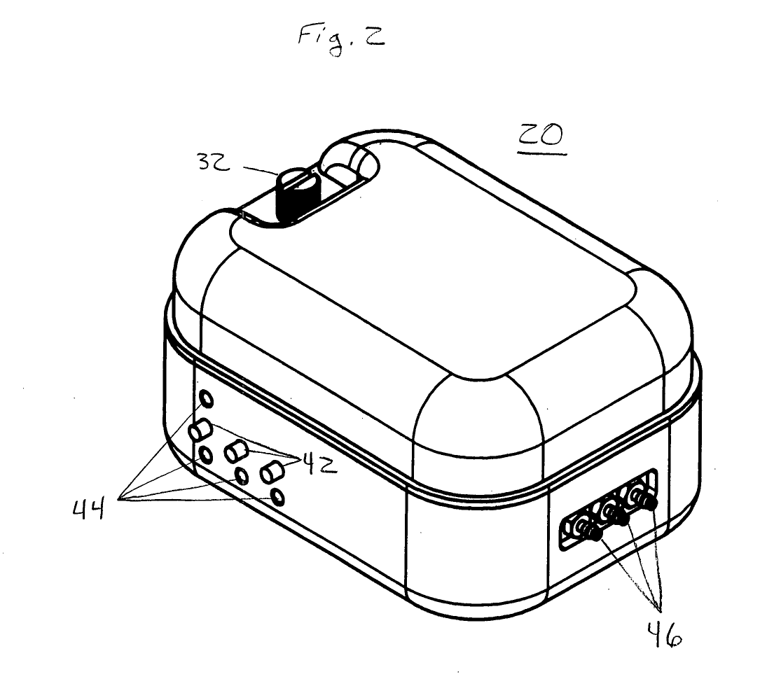

The bladders 2, 4, 5 are connected via pneumatic lines 12 to a compressor and controller unit (illustrated in FIG. 2) in a pouch 1 on the bladder-bearing portion 11 of the compression sleeve. At least a portion of the pneumatic lines are preferably routed within the compression sleeve portion 11, both to minimize exposure to potential damage, and for patient comfort and convenience (avoiding dangling lines and direct-contact pressure points from lines routed on the inside surface of the compression sleeve). The lines also may be alternatively routed, such as on the outside or inside surfaces of the compression sleeve, as long as they connect the bladders with the compressor to permit control of bladder inflation.

At the bottom of the pouch 1 is a coupling device 3 which securely connects the concealed and/or contained pneumatic lines connected to each of the three inflatable chambers 2, 4, 5 to the compressor and controller unit. Preferably, the coupling 3 is located within the pouch for its protection, and to facilitate easy removal and insertion of the compressor and controller unit from/to the pouch 1. The coupling device 3 is not limited to a bottom-of-the-pouch location, but may be located at any desired location, including inside, outside or near the pouch 1, or on the on the sleeve itself is a pouch is not present.

FIG. 2 illustrates the compressor and controller unit 20 of this embodiment. The compressor and controller unit 20 integrates a compressor section and a controller section into a common housing; however, these units may be housed in separate housings, as long as the controller is coupled with the compressor section to control inflation and deflation of the compression bladders.

The compressor and controller unit 20 of this embodiment has two parts, upper removable rechargeable battery housing 30 and lower compressor housing 40. Other arrangements, such as a one-piece housing or a multi-part housing, will be readily apparent to one skilled in the art. Three control buttons 42 and status indicator LEDs 44 (discussed further, below) are located on a side of compressor and controller unit 20. In addition, three hose connections 46 are located on another side of the compressor and controller unit 20.

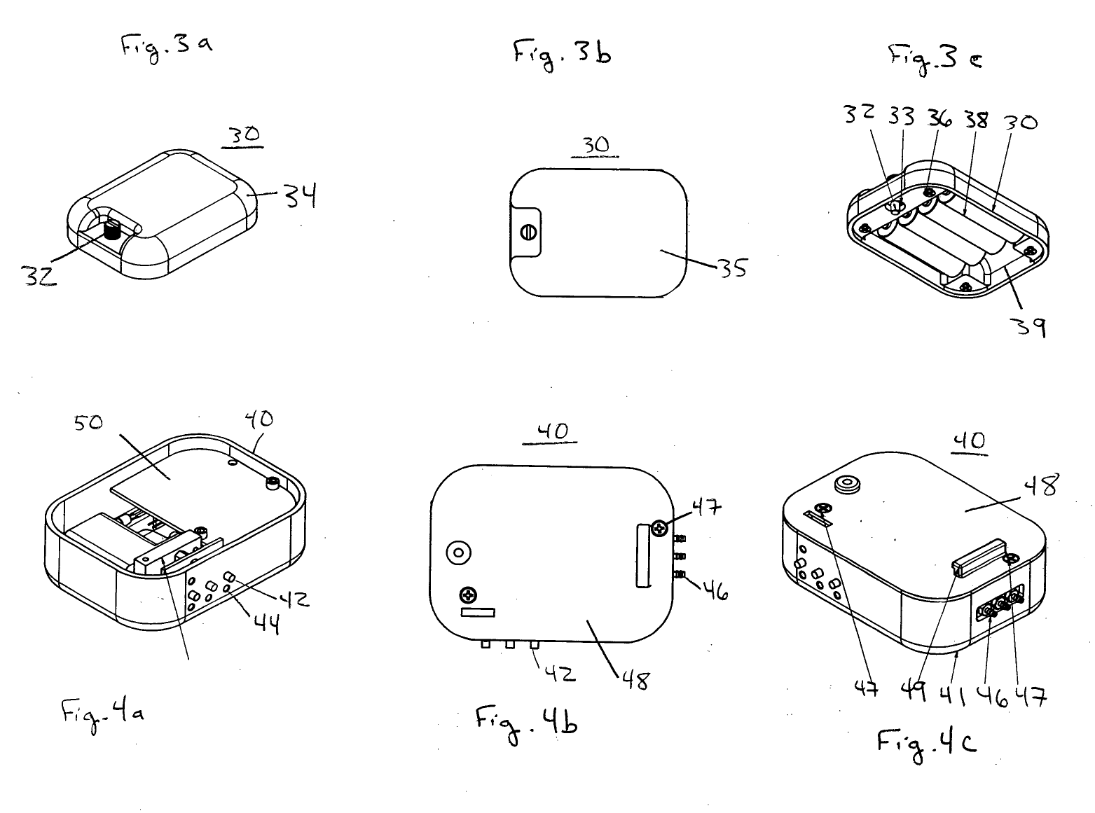

FIGS. 3a-c show details of the upper removable rechargeable battery housing 30. The upper housing 30 is secured to the lower housing 40 by a thumbscrew 32 which passes through opening 33 in this embodiment. Alternative fastening techniques may be used; however, because such alternatives will be plain to those of ordinary skill in the art, they are not illustrated further. The top surface 34 of the upper housing 30 is rounded to minimize wear and other damage to the non-rigid compression sleeve. FIG. 3b shows the inside surface of the upper housing 30, with battery cover panel 35 in place, and FIG. 3c is a view looking into the upper housing 30 with cover plate 35 removed, showing an arrangement of battery cells 38. The upper battery housing 30 also includes a recharge circuit board and a plug (both not illustrated) to accept an input from a plug in transformer that can recharge the batteries and operate the unit at the same time. Cover panels inside the upper housing are secured by screws 36. In this arrangement, a gap 39 is provided at the end of the batteries opposite the thumbscrews 32 to receive a retaining element 49 from the lower housing 40 to assist in securing the upper and lower sections together.

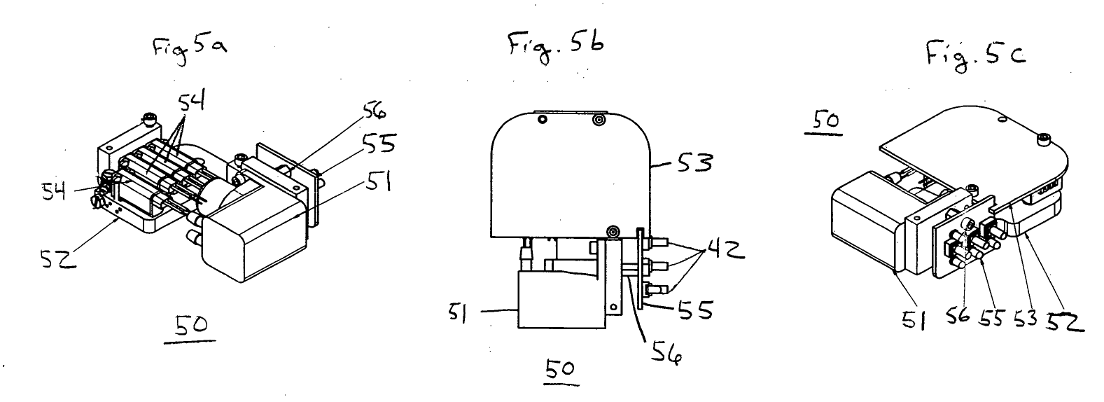

The lower compressor housing 40 shown in FIGS. 4a-c houses both the controller and compressor modules in an integrated assembly 50 which is inserted into the lower housing 40, such that the control buttons 42 and hose connections 46 protrude through the lower housing body. As with the upper housing 30, the exterior surface 41 of the lower housing is rounded to avoid compression sleeve damage. A cover plate 48 secures compressor and controller assembly into the lower housing 40, with the aid of two screws 47.

FIGS. 5a-c illustrate the integrated compressor and controller assembly 50. The assembly includes a compressor 51, a pressure distribution manifold base 52 which is pneumatically connected to compressor 51 by pressure lines (not illustrated), a controller circuit board 53, four solenoid valves 54 connected by electrical conductors to circuit board 53 (connections not illustrated), and a push button circuit board 55 which is secured to that assembly by stand-offs 56.

The three push buttons 42 located on circuit board 55 include a first power button, which will illuminate a red LED above the button. The second button will activate the three chamber program (discussed further below) and will illuminate a red LED above the button. The third button will activate the single chamber program (discussed further below) and will illuminate a red LED above the button. The fourth LED in this embodiment is a three color LED which illuminates green with full battery power, yellow with medium battery power and red with low battery power. In addition, at any time there is an error with the program running in controller 53, the red LED above its associated button will flash.

The following describes the operation and operating method of this embodiment, starting with description of a first sequential program operation. One of the advantages of the present invention is its very simple, convenient set-up and use. In order to set-up this embodiment of the mechanical prophylaxis device for use, the user need only connect the compression and controller unit 20 to coupling device 3 in pouch 1, and push the appropriate buttons 42 to start the unit, as described below. The buttons 42 may be actuated either before or after the compression and controller unit 20 is inserted into pouch 1.

Operation of the mechanical prophylaxis device 10 of this embodiment is as follows: First, power is supplied to the controller either by battery or plug in transformer. Next, the operator pushes the power button to activate the unit, at which time the red LED above the power button will illuminate and the battery LED will illuminate green, yellow or red to indicate battery strength. Next, a first program button is depressed to start the first inflation program. The controller then commands the compressor 51 to start and directs a first one of the solenoid valves 54 to open. The controller then monitors pressure in bladder 5 until the bladder is inflated to 50 mm Hg or 1 psi. Remaining bladders 4 and 2 are then sequentially inflated, with the controller commanding the first solenoid valve 54 to hold pressure in bladder 5 while a second one of the solenoid valves 54 is opened to permit pressure to enter bladder 4. Once bladder 4 is inflated to 50 mm Hg or 1 psi, the second of the solenoid valves 54 is closed by the controller, and a third of the solenoid valves 54 is opened to permit routing of the compressor output to bladder 2. Once all of the bladders 2, 4, 5 are inflated, the controller commands closure of the third of the solenoid valves, and subsequently commands the fourth of the four solenoid valves 54 to open. This fourth solenoid valve communicates with all of the bladders 2, 4, 5 through manifold base 52, and is vented to the atmosphere. Accordingly, the opening of the fourth solenoid valve results in simultaneous deflation of all of the bladders 2, 4, 5. This inflation/deflation sequence is repeated, for example on a frequency of 15 seconds for the inflation/deflation sequence, followed by a 15 second period of inactivity before inflation is resumed. The specific parameters noted above are illustrative only, and are not limiting, and thus parameters such as pressures and time intervals may significantly vary from the foregoing within the scope of the present invention.

Preferably, the controller is programmed to provide more than one inflation sequence program. For example, rather than pushing the first program button in the above operation, a second program button may be pushed to activate a second program which only inflates a single bladder, such as bladder 4. In this program embodiment, the controller commands the compressor to inflate bladder 4 to 130 mm Hg or 2.5 psi, followed by opening of the fourth solenoid valve 54 to open to vent bladder 4 to atmosphere, on a cycle of 10 seconds of inflation/deflation followed by 50 seconds of inflation inactivity.

The compressor and controller unit 20 also may be provided with the capability to be allow an operator, preferably a health care provider or technician, to select from predetermined inflation/deflation control programs stored with controller circuit board 53, such as by operating the control buttons 42 is in a predetermined sequence. Alternatively, the compressor and controller unit 20 may be provided with a computer interface connection which permits selection of predetermined programs from a remote programming device and/or download of desired inflation/deflation control programs to the controller.

Advantages of the mechanical prophylaxis device of the present invention with its integrated compression sleeve, air lines, bladder and coupling device include convenient and easy use by a patient; convenient and easy programming and set-up by health care professionals; ability to use the device in a sterile environment without violation of sterile boundaries, lack of dangling lines which can snag obstacles and cause patient injury and/or discomfort; increased patient compliance as a result of the device's convenience and ease of use (including a greater likelihood of continued patient use due to the device's ability to operate in at any time and in any position, i.e., it is more likely the patient will leave the device on and active as he or she moves between locations); and potentially significantly lower post-procedure VTED incidence in a greater fraction of the patient population due to greater use of mechanical prophylaxis devices outside of hospital environments.

In a further embodiment, the design and operation of the device is simplified from a user's perspective, by reducing the exterior controls to a single operating button. In this embodiment, the compressor and controller unit is provided with an inflation manifold which mates with a standardized multi-port coupling on the compression sleeve. Regardless of the number of inflation bladders provided on or in the compression sleeve, the standardized coupling presents the compressor and controller unit with a standardized interface. When connected and activated, the controller determines the number of bladders are present by sensing which ports of the coupling are blocked and which are connected to a respective inflation bladder, and accordingly selects an inflation sequence to execute. For example, once activated, the controller may automatically execute a first test sequence in which inflation pressure is sequentially applied to each of the ports of the standardized coupling component. During this sequential inflation, the controller monitors the response to each pressure application, for example by determining the amount of time it takes to reach a predetermined pressure. In this manner, the controller may quickly and easily determine which of the coupling ports are blocked, indicating the absence of an inflation bladder, and which coupling ports have an inflation bladder connected to receive inflation pressure. Based on the results of the pressure testing, the controller may then automatically select and initiate execution of a bladder inflation sequence which corresponds to the detected bladder configuration. In this embodiment, the inflation/deflation sequence would proceed until interrupted by a second actuation of the unit's single operating button. The pressure testing routine may also be further enhanced with additional capabilities, such as detecting errors when inflation pressure does not rise to a predetermined level within a predetermined period, indicating a faulty connection or a puncture in an inflation bladder or line.

The features of pressure testing and automatic inflation/deflation sequence selection is not limited to the foregoing embodiment, but may be used with any suitable embodiment, including the first embodiment described above. One of the advantages of this feature is that it permits a single compressor and controller unit to be compatible with a wide variety of different compression sleeve configurations equipped with a standardized coupling.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A portable, self-contained prophylaxis device, comprising:
a non-rigid compression sleeve formed to be worn around at least a portion of an appendage;
at least one compression bladder located on or in the non-rigid compression sleeve;
a compressor;
a controller situated in a common housing with the compressor; and
a pneumatic conduit arranged to communicate pneumatic pressure from the compressor to the at least one compression bladder,
wherein
the sleeve has a holder comprising at least one of a pouch and a holding device arranged to hold the housing,
the pneumatic conduit is integrated into the compression sleeve and includes a coupling device situated in the holder and at least one air line which connects the coupling device with the at least one compression bladder,
the compressor housing includes a manifold arrangement releasably connectable to the coupling device, the manifold arrangement including at least one supply valve through which the compressor communicates with the at least one compression bladder, and at least one solenoid valve which responds to controller commands to vent pressure from the at least one compression bladder.

2. The prophylaxis prevention device of claim 1, wherein
a plurality of compression bladders are provided on or in the non-rigid compression sleeve,
the compressor communicates with each of the plurality of compression bladders, and
the manifold arrangement includes a plurality of solenoid valves which selectively at least one of seal and vent pressure from the plurality of compression bladders.

3. The prophylaxis prevention device of claim 2, wherein
the controller is programmed to control inflation of at least one the plurality of compression bladders independently of another one of the plurality of compression bladders.

4. The prophylaxis prevention device of claim 1, wherein
the controller includes a plurality of selectable compression bladder inflation control routines.

5. The prophylaxis prevention device of claim 3, wherein
the controller includes a plurality of selectable compression bladder inflation control routines.

6. The prophylaxis prevention device of claim 4, wherein
the controller is programmed to determine the arrangement of compression bladders connected to the coupling device, and to select an inflation control routine for execution based on the determined arrangement of compression bladders.

7. The prophylaxis prevention device of claim 1, wherein
the controller further includes a housing portion containing a removable battery.

8. The prophylaxis prevention device of claim 1, wherein
the appendage is one of a leg, a foot, an arm and a hand.

9. A method of operating a portable, self-contained prophylaxis prevention device, the prophylaxis device including a non-rigid compression sleeve formed to be worn around at least a portion of an appendage, at least one compression bladder located on or in the non-rigid compression sleeve, a compressor, and a controller situated in a common housing with the compressor, and a pneumatic conduit arranged to communicate pneumatic pressure from the compressor to the at least one compression bladder, wherein the sleeve has a holder comprising at least one of a pouch and a holding device arranged to hold the housing, the pneumatic conduit is integrated into the compression sleeve and includes a coupling device situated in the holder and at least one air line which connects the coupling device with the at least one compression bladder, the compressor housing includes a manifold arrangement releasably connectable to the coupling device, the manifold arrangement including at least one supply valve through which the compressor communicates with the at least one compression bladder and at least one solenoid valve which responds to controller commands to vent pressure from the at least one compression bladder, comprising the steps of:
placing the non-rigid compression sleeve on the appendage,
inflating the at least one compression bladder with said compressor in response to a command from a control program of the controller.

10. The method of claim 9, wherein
in the inflating step, at least one the plurality of compression bladders is inflated independently of another one of the plurality of compression bladders.

11. The method of claim 9, wherein
the controller includes a plurality of selectable compression bladder inflation control routines.

12. The method of claim 10, wherein
the controller includes a plurality of selectable compression bladder inflation control routines.

13. The method of claim 11, further comprising the steps of:
applying pressure to each air line connected to the coupling device;
determining a pressures response for each air line to which pressure is applied;
determining from the detected pressure response of each air line which air lines are connected to inflation bladders,
wherein the inflating step is performed in accordance with a routine executed by the controller based on the results of the pressure response determining step.

14. The method of claim 12, further comprising the steps of:
applying pressure to each air line connected to the coupling device;
determining a pressures response for each air line to which pressure is applied;
determining from the detected pressure response of each air line which air lines are connected to inflation bladders,
wherein the inflating step is performed in accordance with a routine executed by the controller based on the results of the pressure response determining step.

15. The method of claim 10, wherein
the controller further includes a housing portion containing a removable battery.

16. The method of claim 9, wherein
the appendage is one of a leg, a foot, an arm and a hand.
